(19) United States
(12) Patent Application Publication
(10) Pub. No.: US 2004/0168171 A1
(43) Pub. Date: Aug. 26, 2004

(54) Work flow explorer

(76) Inventors: Robert Comparato, Sparta, NJ (US); Frank Grande, Oakland, NY (US); Olli Jason, Milford, PA (US); Frank Librera, Commack, NY (US); George Hinchcliff, Cornwall, NY (US); Richard Nash, Medford, NY (US)

Correspondence Address: BAKER & BOTTS, 30 ROCKEFELLER PLAZA, NEW YORK, NY, 10112

(21) Appl. No.: 10/704,069

(22) Filed: Nov. 7, 2003

Related U.S. Application Data
(60) Provisional application No. 60/424,572, filed on Nov. 7, 2002.
(60) Provisional application No. 60/424,574, filed on Nov. 7, 2002.

(51) Int. Cl. H04N 3/36

(52) U.S. Cl. 718/106; 718/102

(57) ABSTRACT

A method is provided that collects, analysis and graphically displays the relationship between processing jobs, files and systems within a batch environment. Job processing order is illustrated using flow charts that display dependencies between jobs and files. Dependencies exist when jobs are triggered by other jobs and/or files and by jobs that require files created by other jobs. By selecting a starting job or file, and the direction of the stream, a user can view either successor or predecessor information. In addition to flowcharts detailed information, such as run-time schedules, location, ownership, help telephone member, etc. is available about each individual job and file. The data to create the display is regularly collected from a scheduling system (such as CA7) parsed and downloaded onto a file server where it is analyzed and prepared for access by the graphic user interface over a local area network.

This application claims the benefit of Provisional application Serial No. 60/424,572, filed Nov. 7, 2002.

### BACKGROUND OF THE INVENTION

This invention relates to computer systems, and particularly to data processing systems which execute a plurality of applications on data contained in a plurality of data files wherein a scheduling program is used to arrange the order of processing of the applications and processing jobs included therein by the data processing system.

In such complex data processing systems the applications which are executed may each include one or more data processing jobs. The jobs must be executed in an order that is specified by a scheduling program, so that data that is required by one processing job, which is a result of another data processing job, will be available when the processing job is run. For this purpose a Computer job, such as CA7, which is available from Computer Associates, or other scheduling program, such as Operation Planning and Control (OPC), available from IBM, can be used to schedule data processing jobs in a complex data processing system. The application and processing jobs in such systems frequently undergo revisions and changes, so that the aforesaid scheduling program is required to reschedule the operation of the various applications and the various data processing jobs contained therein on a frequent basis. For example the data processing system operated by the assignee of this invention for stock trading and clearance processing may involve several hundred applications having 48,000 data processing jobs and 100,000 data files. These applications are frequently updated. This fact makes it difficult for system operators and analysts to know precisely the order of execution of data processing jobs contained within the application programs being executed, and accordingly can make it difficult when an exception occurs, for example, one of the data processing jobs is not properly executed or some of the data files, to be used in the data processing jobs of the application software, are corrupted by an event. It is an object of the present invention to provide a method which provides a graphic display of the dependency of selected data processing jobs in a data processing system according to the current arrangement of the system, so that when an exception occurs, those responsible for operation of the system have a facilitated way of viewing which particular data processing jobs and which particular data files may have been corrupted by the exception.

The system used by the assignee of this application, in addition to using a computer job scheduling program, uses special programs for tracking and routing data into and out of the system. One program called DataTrack tracks data entering the system according to the origin and nature of the data. For this purpose an identification number, called a “sysid” is assigned to each incoming data-set. Another program called AutoRoute is used to send processed data out of the system.

### SUMMARY OF THE INVENTION

In accordance with the invention there is provided a method for providing a graphic display of the order of processing of jobs in a data processing system for executing a plurality of applications on data contained in the plurality of data files, wherein each application includes one or more data processing jobs. At least some of the jobs can be executed only after completion of execution of other jobs. A scheduling program is used to arrange the order of processing of the jobs by the data processing system. According to the method of the invention data is derived from the scheduling program which represents the order of processing. The order of processing data is analyzed to derive data representing processing job dependencies. A set of graphic display data is generated using the data representing processing dependencies. The data display includes diagram data showing dependencies of data processing jobs. Selectable portions of the display data is provided on a computer video display.

In accordance with a further aspect of the invention data may be derived from the order of data processing representing dependency of the processing jobs on one or more data files. The graphic display can then be generated using the data file processing job dependency. Selectable portions of the graphic display data can be provided to give a graphic illustration of the dependency of a selected job on other processing jobs and data files. In addition, in connection with displaying selectable portions of the display data there may be provided a graphic illustration of processing jobs which are dependent on a selected job. In addition, data from the order of processing data representing dependency of the processing job on one or more data files may be derived and the graphic display can be provided.

In accordance with the invention there is provided a method for use in a data processing system for executing a plurality of applications on data contained in a plurality of data sets wherein each of said applications include one or more data processing jobs and wherein some of said jobs can be executed only after completion of execution of other job and wherein a scheduling program is used to arrange order of processing of the jobs by the data processing system. The method is for recovering from a data processing error and includes deriving data from the scheduling program representing the order of processing. The processing order data is analyzed to derive data representing processing job dependencies. Graphic display data is generated using the data representing processing job dependencies. The display data shows dependencies of data processing jobs. Portions of the display data are displayed to a user and are selectable in accordance with the data processing error to thereby provide a graphic display of data processing job effected by the data processing error. Following correction of the error the effected data processing jobs can be repeated.

According to a preferred embodiment of the invention where the data processing error results in corruption of one or more data files, the method further includes deriving data from the order of processing data representing dependency of said processing job on one or more data files, generating the graphic display data using the data file processing job dependencies and displaying portions of said graphic display data to provide a display of processing jobs and data files effected by the one or more corrupted data files. The effected data processing jobs are repeated when the data processing error has been corrected and the one or more corrupted data files have been corrected.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a block diagram illustrating a computer system in which the method of the present invention may be practiced.

FIG. 2 is a flow diagram illustrating an embodiment of the method of the present invention.

FIG. 3 is an illustration of a graphic user interface display according to one embodiment of the present invention.

FIG. 4 is an alternate graphic user interface display available according to an embodiment of the present invention.

FIG. 5 is still another alternate graphic user interface display available according to an embodiment of the method of the present invention.

FIG. 6 is still another alternate graphic user interface display available according to an embodiment of the method of the present invention.

FIG. 7 is still another alternate graphic user interface display available according to an embodiment of the method of the present invention.

FIG. 8 is still another alternate graphic user interface display available according to an embodiment of the method of the present invention.

FIG. 9 is still another alternate graphic user interface display available according to an embodiment of the method of the present invention.

FIG. 10 is still another alternate graphic user interface display available according to an embodiment of the method of the present invention.

FIG. 11 is still another alternate graphic user interface display showing a query feature display according to a n embodiment of the method of the present invention.

FIG. 12 is still another alternate graphic user interface display showing a main toolbar available according to an embodiment of the method of the present invention.

FIG. 13 is still another alternate graphic user interface display available according to an embodiment of the method of the present invention.

FIG. 14 is still another alternate graphic user interface display available according to an embodiment of the method of the present invention.

### DESCRIPTION OF THE INVENTION

Referring to FIG. 1 there is shown a data processing system which includes a processor 12, which may be, for example, a group of computers linked together for processing data which results from stock trading at an exchange. Processor 12 is provided with a plurality of data processing application programs which need to be executed on the data which has been accumulated during a day's trading. The applications each include one or more data processing jobs, and at least some of the jobs can be executed only after completion of execution of other jobs or when one or more data files which result from other jobs or from data transfers are available. Processor 12 includes a scheduling program, which may, for example, be CA7. The scheduling program arranges a sequence of execution of the data processing jobs for the applications according to the requirements of each data processing job, and the availability of data files required for execution of each data processing job.

In a complex system, such as stock exchange data processing, the actual applications being run may change on an almost daily basis. Accordingly, the scheduling program CA7 rearranges the order of execution of applications and data processing jobs for applications to efficiently execute the required data processing following each modification of the underlying applications and data processing jobs.

One problem that has been realized with the rearrangement of data processing jobs, in accordance with the use of a scheduling program, is that it becomes difficult for system operators to know which data processing jobs may have been effected by an exception in the data processing system, and accordingly which data processing jobs may have to be repeated when the exception is noted and corrected. In addition, it becomes difficult for the system operators to know what programs may have-given rise to errors in the execution of data processing jobs in the sequence. The difficulty arises because there has previously been no arrangement to provide a graphic display which represents the sequence of job execution according to the current configuration by the scheduling program, in order to easily determine the interdependency of the data processing jobs and data files.

In accordance with the present invention the computer system 10, in addition to the data processor 12, is provided with a server 14, at least one work station 16, connected as a client to server 14 over a network, and having a display 18. The work station 16 and display 18 are for use by a data processing operator to view the sequence of jobs in accordance with a display generated according to the present invention.

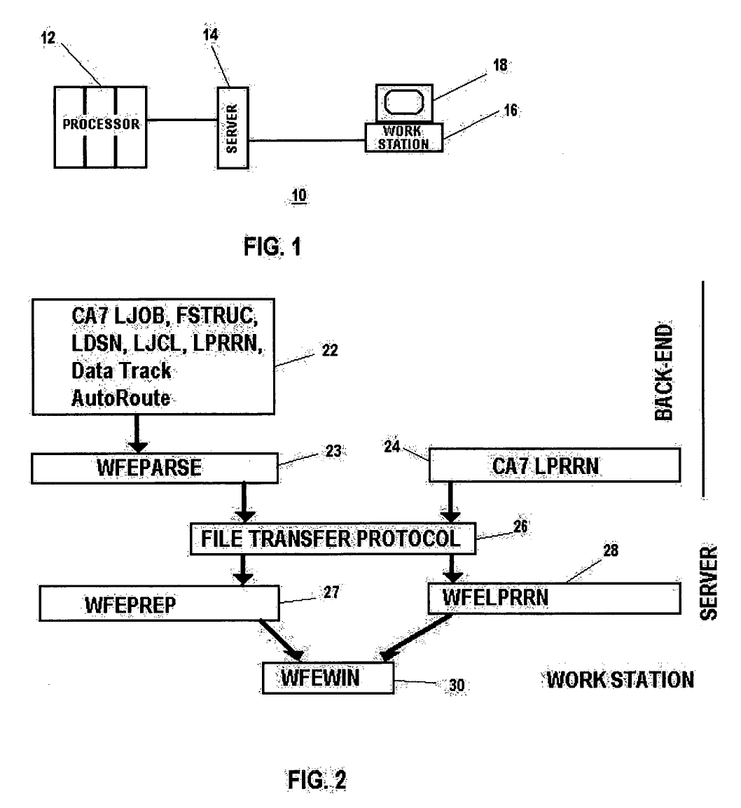

FIG. 2 is a flow diagram illustrating the sequence of operations of the present invention in preparing data for a sequence display for the system operator at work station 16 on display 18. In the first step 22, data within the scheduling program is parsed to obtain the appropriate portion of the data representing the order of processing of the data processing jobs and the generation of data-sets. The data sources within the CA7 program are the LJOB, the LDSN, the FSTRUC and the LPRRN data files. In addition, the Sysid summary report of the Data Track program and the AutoRoute input/output control program running on processor 12 are available to provide data. The data is parsed and put into a file transfer program operating to transfer the order of processing data from the processor 12 to the server 14. In addition LPRRN data 24 representing prior run information from the CA7 program is made available to server 14.

The WFEPARSE program 23 operates on the mainframe operating system, such as OS/390, and builds detail and requirements information on all CA7 jobs, data-sets and Data Track sysids by parsing and combining data from the different input files on a daily basis, including the following input files:

CA7LDSN comprising details of all data-sets defined to CA7 along with a data-set to job cross-reference.

CA7LJOB comprising comprehensive job detail and requirements information on all jobs defined to CA7.

CA7FSTR comprising stream information listing job and data-set triggers.

CA7LPRR listing prior run information for each job

LISTJCL listing JCL library names associated with a JCL Id number found in CA7LJOB file.

ARDETAIL comprising detailed routing information from AutoRoute program.

ARPRDUCT giving parameters parsed out of production JCL connecting jobs to AutoRoute products.

DTRSUMM Data Track Sysid report containing sysid detail and a cross-reference to jobs.

By parsing the data contained in the CA7, AutoRoute and Data Trak files listed above, WFEPARSE generates the following output files in fixed column format:

JOBDTL having combined details from CA7LJOB, CA7LPRR, LISTJCL, and ARPRDUCT

DSNDTL having details from CA7LDSN.

DTRDTL having details from DTRSUMM

JOBREQ having job requirements combined from CA7LJOB, CA7LDSN and DTRSUMM.

DSNREQ having data-set requirements collected from CA7LDSN

DTRREQ having Data Track Sysid requirements. This file currently just lists the sysids as there are no included predecessors to them.

ARPROD having Auto Route Product and destination detail combined from ARDETAIL and ARDESTIN.

ARJOBPD having job to AutoRoute Product cross-reference collected from ARPRDUCT.

LJOBDMP having LJOB information for each job in original format.

The output files from the WFEPARSE program 23 and LPRRN files 24 are transferred under a file transfer protocol 26 to Server 14, which performs a data preparation process WFEPREP 27. WFEPREP operates on a PC server operating system, such as Windows NT, and splits job, data-set and product detail files into directories. Each job/data-set/product/sysid information related directory contains a file for each job/data-set/product/sysid. WFEPREP constructs list files containing all jobs, data-sets, products, and sysids found in detail and requirements files. These files are written to the CURRENT directory. WFEPREP further builds PRED.BIN and SUCC.BIN files containing respectively one level of predecessors and successors for every object type. These files are also written to the CURRENT directory. WFEPREP expects a project file name (,wfp) as an executable parameter. This file needs to reside in the parent directory of the executable directory (/bin). The file contains the name of the project directory, which will be used to determine the directory paths for input and output files. All files in the DOWNLOAD directory are copied to HISTORY. Currently, 40 days of data is kept. The HISTORY/01/ contains yesterday's files and HISTORY/02/ contains files from two days ago. WFEPREP compares the file date information on the LJOBDMP file between the DOWNLOAD directory and the HISTORY. WFEPREP prepares the following files using the data in the output files from WFEPARSE:

ARJPD DIR containing a file for each job that creates an AutoRoute Product. Each file contains the name of the product.

AUTOROUTE DIR containing a file for each AutoRoute Product. Each file contains the product and its destination detail.

DSNDTL DIR containing a file for each CA7 DSNBR. Each file contains a record listing the physical dataset name along with the CA7 detail.

DSNXREF DIR containing a file for each CA7 DSNBR. Each file contains a list of jobs that reference each data-set and jobs that create the dataset.

DTRDTL DIR containing a file for each Data Track Sysid. Each file contains a record listing AutoRoute report detail.

JOBDEP DIR containing a file for each job that has dependencies. Each file contains lists of jobs and data-sets the job is dependent on.

JOBDTL DIR containing a file for each job in CA7. Each file contains a record listing CA7 detail, run information, and JCL library name.

LJOBDMP DIR containing a file for each job in CA7 that has LJOB information. Each file contains the entire LJOB NODD data for the job.

ARPLIST.BIN containing a list of all AutoRoute Products.

DSNLIST.BIN containing a list of all CA7 DSNBR with their physical data-set names.

DTRLIST.BIN containing a list of all Data Track Sysids.

JOBLIST.BIN containing a list of all jobs in CA7.

PRED.BIN containing all immediate (one level) predecessors for all jobs, data-sets products and sysids.

SUCC.BIN containing all immediate (one level) successors for all jobs, data-sets, products and sysids.

Server 14 additionally runs WFELPRRN program 30 which splits the CA7 prior run information file into a directory. This program is run on an hourly basis to update information in records that contain run-time information relating to the past hour. A complete refresh of the directory is performed on a daily basis.

The output files from WFEPREP and WFELPRRN are thereafter provided to a windows display generating system 30 which provides a windows display to the operator showing portions of the work flow diagram which are of interest in the particular situation.

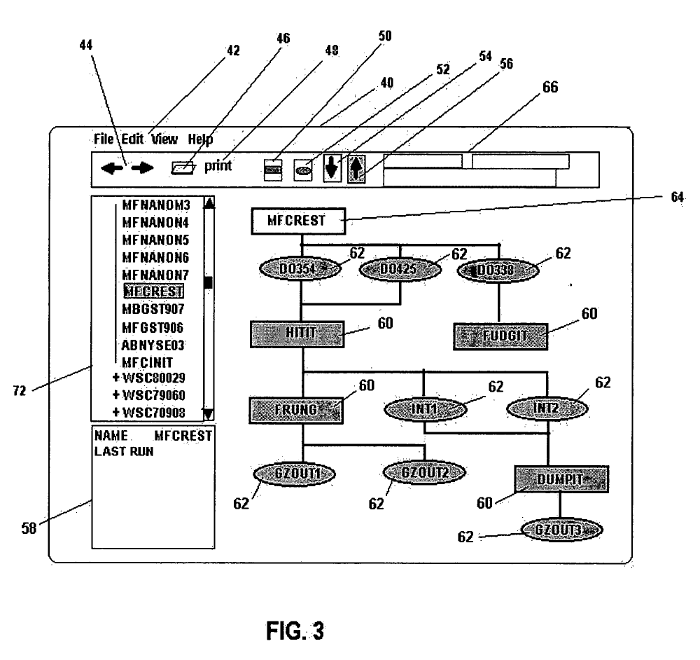

FIG. 3 is a diagram showing a display available in accordance with an embodiment the present invention. The FIG. 3 display is in the format of a windows-type display and includes a display header 42 and toolbar 66 for performing various functions with respect to the display. A side window 72 includes a list of programs which may be selected for purposes of illustrating a flow diagram. A second window 58 provides the operator with information concerning the program which is highlighted by clicking on to the program name in the user interface window 72 of FIG. 3. In the illustration a program MFCREST has been selected. In addition, the operator has selected icon 54 in the tool bar 66 to illustrate the dependencies of other data sets and programs on program MFCREST. Accordingly, MFCREST is displayed in a highlighted manner on the display window at point 64 and the data sets 62 and jobs 60 that depend on MFCREST and follow the selected program are illustrated in the remainder of the diagram. In the embodiment illustrated in FIG. 3 application jobs are in rectangular boxes whereas data files 62 are in oval boxes. The selected application programming job 64 is highlighted and the remaining programming jobs 60 are indicated in the flow diagram but are not highlighted. Icons 44 may be used to move the display left or right where the display is wider than a display capability of the monitor. Icon 46 is the typical open file icon and icon 48 is the print button. Icons 50 and 52 are selectable to filter the display to display either only application jobs or to display only data files, or both as shown in FIG. 3.

The display of FIG. 3 can be selected by an operator who has determined that the application job MFCREST has failed to run. He can then determine what other application jobs and what other outputs have been effected by the failure or have been effected by incorrect data output from a failure of application job MFCREST.

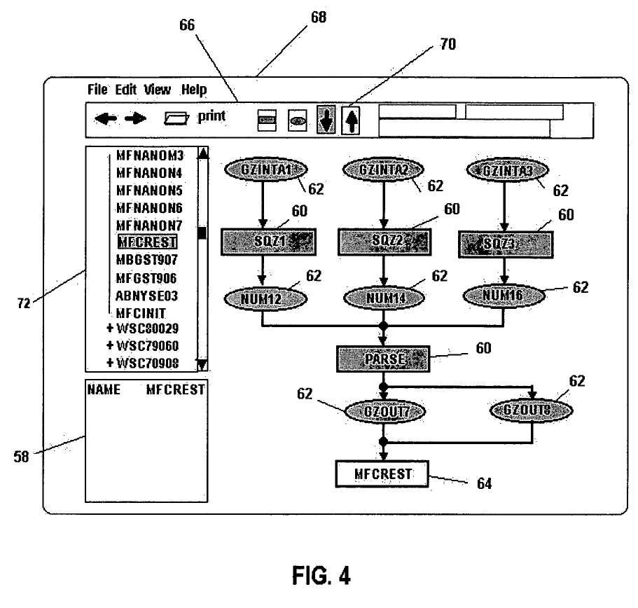

While the display of FIG. 3 is useful to an operator to determine the effect of a failure of operation of application job MFCREST, the display 68 of FIG. 4 is useful for the operator to determine what may have caused the failure or improper operation of application job MFCREST.

In the display of FIG. 4, which is generated by selecting icon 70, the jobs 60 which lead to and the data files on which application job MFCREST 64 depend are illustrated. Accordingly by viewing the sequence of jobs in the flow diagram of FIG. 4 the operator can rapidly identify what other application jobs 60 and other data files 62 or input data may have resulted in an improper operation of the particular application job 64 of interest. Further analysis by the operator as to the condition of these other programs and data sets can lead to resolution of the system problem.

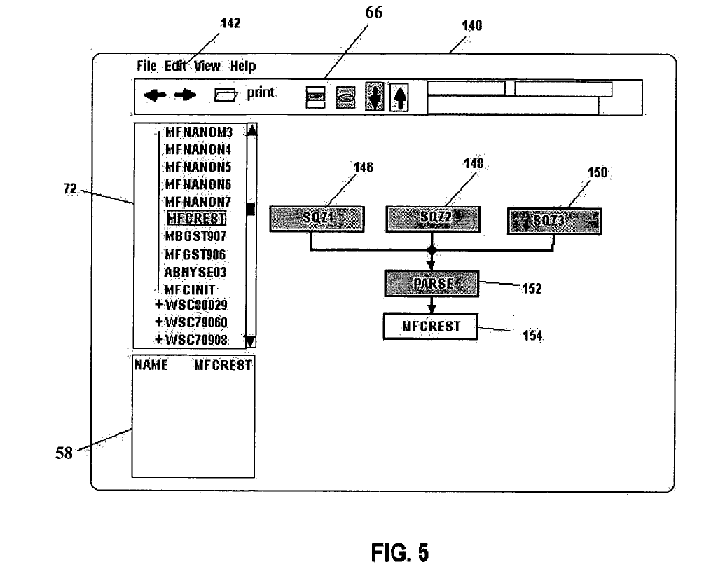

FIG. 5 is a further selectable display 140, available by activation of icon 52 (FIG. 3), wherein the data files have been filtered from the display. Accordingly only the application jobs 146, 148, 150, 152, and 154 in the diagram of FIG. 4 are shown in the diagram of FIG. 5 and the data sets are not shown. This program display may be further useful for giving the operator an indication of what application jobs may be at fault when there are a large number of application jobs leading to selected application job MFCREST.

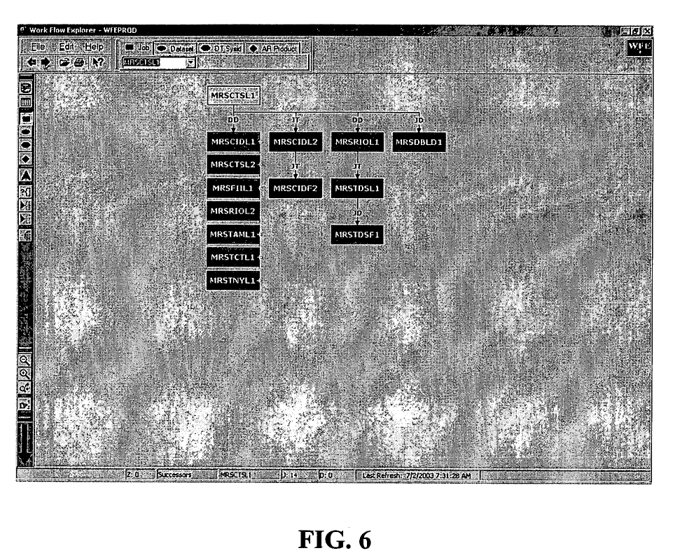

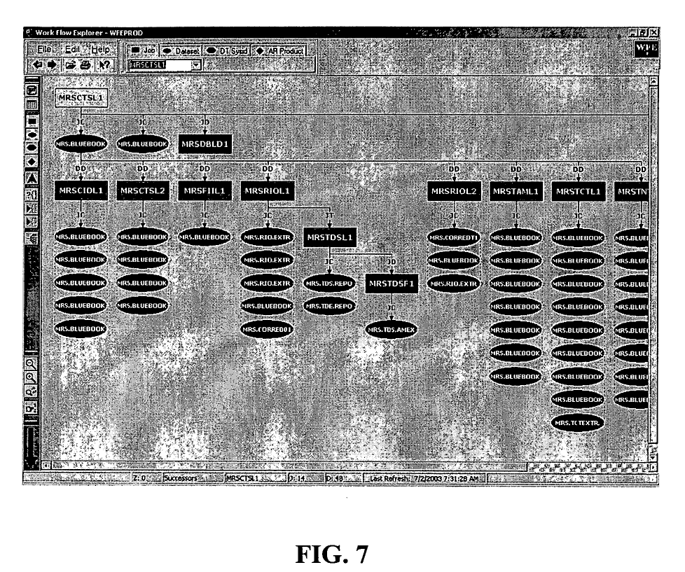

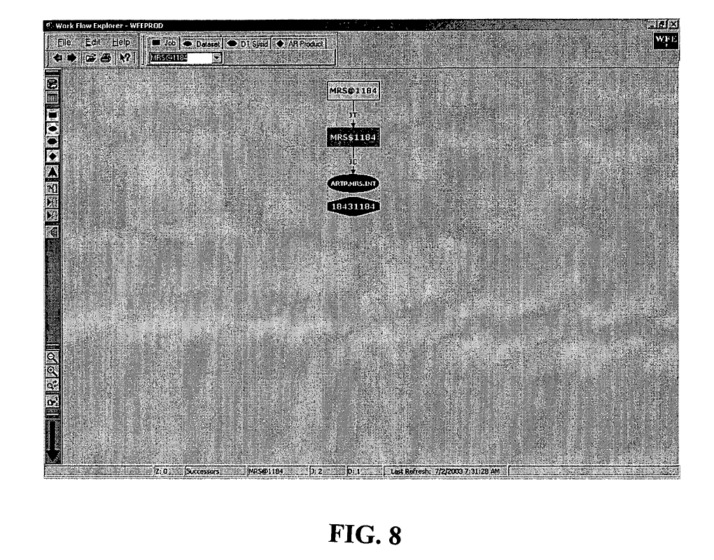

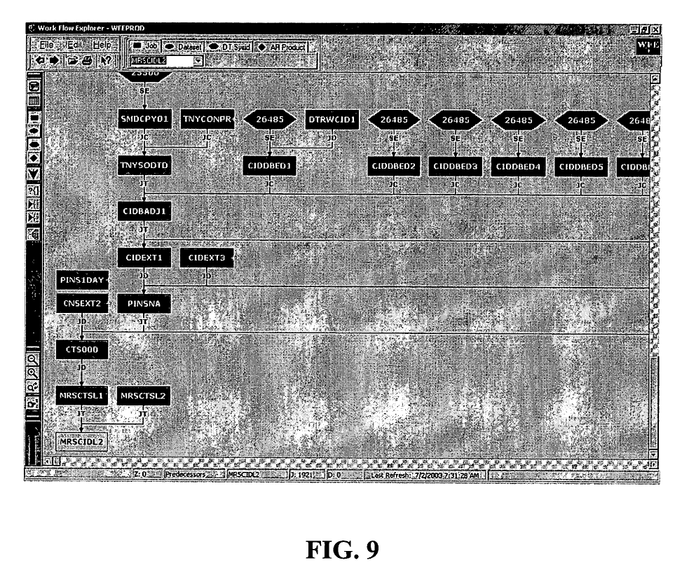

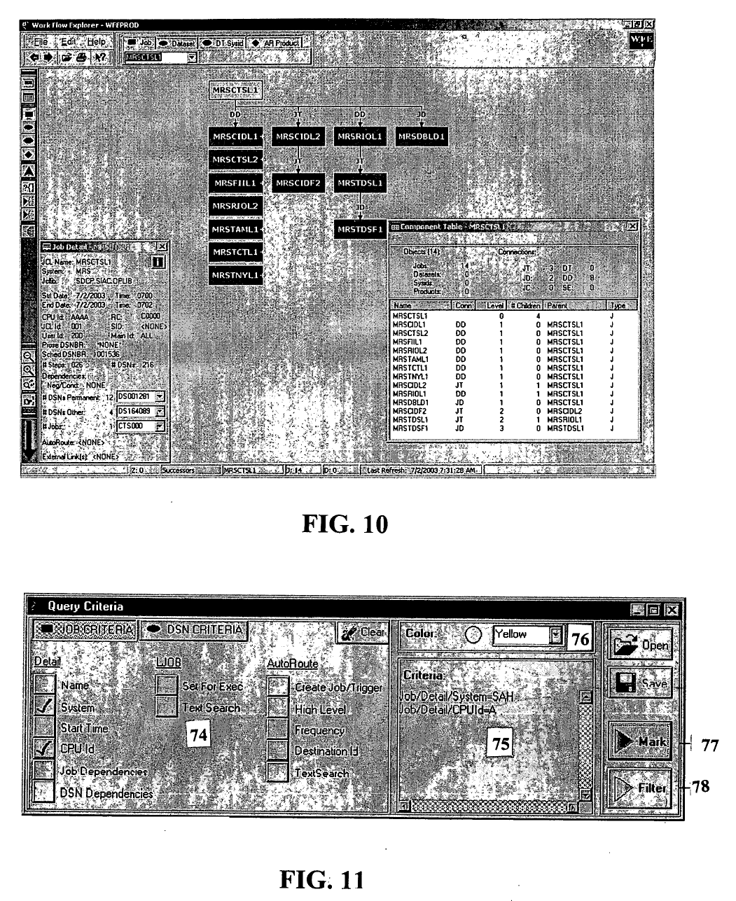

FIGS. 6 through 10 illustrate displays generated by a variation of the invention that, in addition to showing the arrangement of jobs and data-sets, also show the particular dependencies of jobs and triggers for subsequent jobs. FIG. 6 is a display showing jobs without data sets and also showing job triggers (JT), job dependencies (JD) and data dependencies (DD). FIG. 7 shows the same jobs, and also includes the data sets which are shown in ovals. FIG. 8 shows interconnection between jobs and Auto Route, with a job created (JC) data-set sent to Auto Route, and the Auto Route data-set identification in an octagonal box. FIG. 9 shows the reverse view of dependencies with Sysid identifiers from Data Track for input data shown in hexagonal boxes. FIG. 10 shows the display with two windows open. The detail window on the lower left gives details of the selected job run time from the LPRRN data, and other information about the job. A second CA7 window on the lower right provides the current CA7 configuration for a job in the CA7 format.

FIG. 11 illustrates a Windows query display panel display useful for formulating an inquiry and selecting the desired display characteristics by the operator. Panel 74 enables selection criteria in various fields to be entered. When a field is selected by clicking on the adjoining button, a criteria entry window will be brought up. Once a criteria for a field has been entered, a check appears on the button. Criteria can be selected in multiple fields and objects must meet all requirements in order to be selected. Criteria can be selected for either job objects or data-set objects. The selected criteria only apply to the type of object for which the criteria is entered, but both types of criteria can be used to modify a display. Area 75 shows for review the criteria that have been entered. Area 76 provides for selection of a color for highlighting, where the objects on a flow chart that meet the selected criteria are to be highlighted. Button 77 causes the flow chart to be highlighted in the selected color for all objects that meet the specified criteria. Button 78 provides a filtering function to remove from the displayed flowchart objects that do not meet the selected criteria.

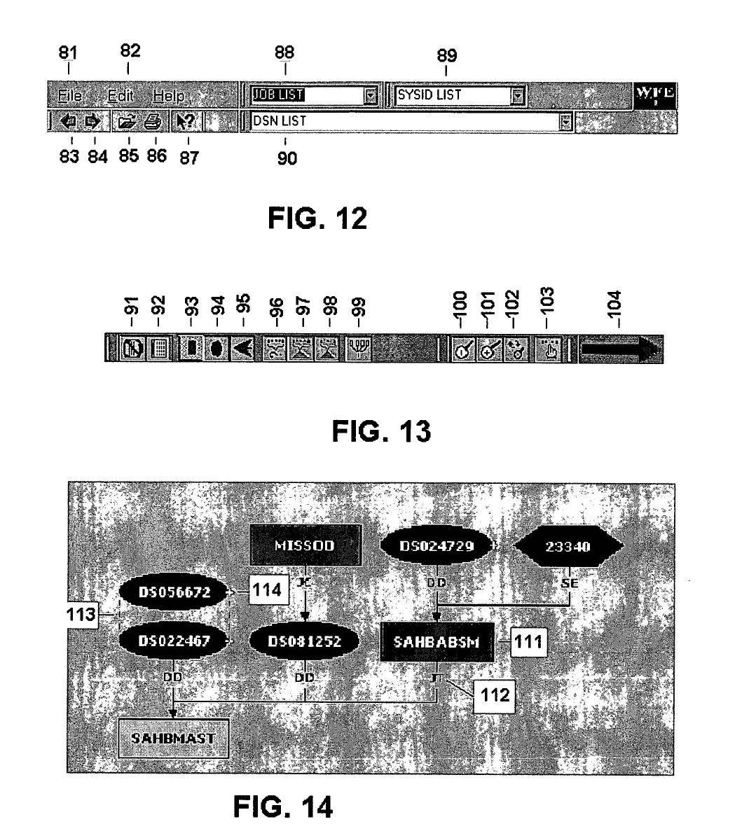

FIG. 12 shows an alternate Main toolbar for use with the invention. The toolbar of FIG. 12 includes a file label 81 which includes the Windows open and print instructions. The open function can be used to point the system at a different database, such as when the system includes jobs and data for multiple customers or multiple functions. The Windows Edit function can be used to copy a flow chart or a selected portion of a flowchart to the Windows clipboard. The Help key can be used for example to display contact information for a customer or for a help desk. Arrows 83, 84 are used for moving to a previous flowchart, or to a next flowchart after moving back. Icons 85, 86 and 87 respective allow direct entry command for file open, print and help functions. Window 88 opens to provide an alphabetical list of jobs. By entering the first part of a name, the appropriate portion of the list can be displayed. Windows 89 and 90 provide corresponding lists for the Data Track Sysid list and data set list.

FIG. 13 shows a flowchart toolbar that can be displayed, for example on the side of a flowchart display. On the flowchart toolbar, icons 91 and 92 are usable to select whether the detail window is to be displayed continuously or only when the left mouse button is depressed. A third detail icon may be provided to enable multiple detail windows to be displayed. Icons 93 and 94 are used to select display of jobs, data-sets or both. Icon 95 is used to select the direction of the flowchart for predecessor or successor jobs and/or data-sets. Icon 96 calls up the query entry window shown in FIG. 11. Icons 97 and 98 enable or disable the highlight and filter functions of the query criteria. Icon 99 causes display of the Data Track Sysids within the current flowchart. Icons 100, 101 and 102 control the zoom-out, zoom-in and reset zoom functions. Icon 103 controls highlighting of the currently selected object in the flowchart. Icon 104 is an indicator of the current direction of the flowchart.

FIG. 14 illustrates an exemplary set of display indications in the flow chart. Rectangles 111 are used for jobs. The job name is within the rectangle. Ovals 114 are used for data-sets and include the CA7 data-set number. The physical data-set name can be viewed by right clicking the object or using the detail mode from the flowchart toolbar and selecting the object by left clicking. Hexagons represent Data Track Sysids with the Sysid number. Object groups 113 which share a common predecessor and connection type are displayed vertically and connected by dotted lines. A plus sign indicates that an object has a predecessor or successor that is not displayed in the flowchart because it is duplicated elsewhere. They will be displayed by double clicking the object. Connections between objects may include:

DD—data-set dependency

DT—data-set trigger

JC—job creates data-set

JD—job dependency

JT—job trigger of successor job

JTD—job trigger and separate dependency

JU—job updates data-set

SE—Prior object is a sysid, successor object is the edit job for the sysid

While the invention has been described with respect to a system that uses CA7 as a scheduling program, it will be recognized by those skilled in the art that the invention may be implemented with other scheduling programs and work in connection with alternate tracking and routing programs.

While there have been described what are believed to be the preferred embodiments of the present invention, those skilled in the art will recognize that other and further changes and modifications may be made thereto without departing from the spirit of the invention, and it is intended to claim all such changes and modifications as falls in the scope of the invention.

I claim:

1. In a data processing system for executing a plurality of applications on data contained in a plurality of data sets, wherein each of said applications includes one or more data processing jobs, and wherein at least some of said jobs can be executed only after completion of execution of other jobs, and wherein a scheduling program is used to arrange order of processing of said jobs by said data processing system, a method for providing a graphic display of said order of processing of said jobs, comprising:
deriving data from said scheduling program representing said order of processing;
analyzing said order of processing data to derive data representing processing job dependencies;
generating graphic display data using said data representing order of processing and dependencies, said display data including diagram data showing dependencies of data processing jobs; and
displaying selectable portions of said display data to a user to provide a graphic illustration of the dependency of a selected job on other processing jobs.

2. A method as specified in claim 1 further comprising deriving data from said order of processing data representing dependency of said processing jobs on one or more data files, generating said graphic display data using said data file processing job dependencies, displaying selectable portions of said graphic display data to provide a graphic illustration of the dependency of a selected job on other processing jobs and data files.

3. A method as specified in claim 1 wherein said displaying selectable portions of said display data further provides a selectable graphic illustration of processing jobs which are dependent on a selected job.

4. A method as specified in claim 3 further comprising deriving data from said order of processing data representing dependency of said processing jobs on one or more data files, generating said graphic display data using said data file processing job dependencies, displaying selectable portions of said graphic display data to provide a graphic illustration of the dependency of a selected job on other processing jobs and data files.

5. A method as specified in claim 4 wherein said displaying selectable portions of said display data further provides a selectable graphic illustration of processing jobs which are dependent on a selected job.

6. In a data processing system for executing a plurality of applications on data contained in a plurality of data files, wherein each of said applications includes one or more data processing jobs, and wherein at least some of said jobs can be executed only after completion of execution of other jobs, and wherein a scheduling program is used to arrange order of processing of said jobs by said data processing system, a method for recovering from a data processing error, comprising:
deriving data from said scheduling program representing said order of processing;
analyzing said order of processing data to derive data representing processing job dependencies;
generating graphic display data using said data representing processing job dependencies, said display data showing dependencies of data processing jobs;
displaying portions of said display data to a user, said portions being selected in accordance with said data processing error, to thereby provide a graphic display of data processing jobs effected by said data processing error; and
repeating said effected data processing jobs after said error has been corrected.

7. A method as specified in claim 6 wherein said data processing error results in corruption of one or more data files, further comprising deriving data from said order of processing data representing dependency of said processing jobs on one or more data files, generating said graphic display data using said data file processing job dependencies, displaying portions of said graphic display data to provide a display of processing jobs and data files effected by said one or more corrupted data files; and repeating said effected data processing jobs when said data processing error has been corrected and said one or more corrupted data files have been corrected.
